(19) United States
(12) Patent Application Publication
(10) Pub. No.: US 2010/0156401 A1
(43) Pub. Date: Jun. 24, 2010

(54) MAGNETIC RESOLVER AND METHOD OF MANUFACTURING THE SAME

(76) Inventors: Masayuki Nishiguchi, Aichi-Ken (JP); Yuji Sekitomi, Aichi-Ken (JP); Toshihiro Kimura, Aichi-Ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/296,288

(22) PCT Filed: Apr. 12, 2007
(86) PCT No.: PCT/IB07/00937

§ 371 Date: Oct. 7, 2008

(30) Foreign Application Priority Data
Apr. 13, 2006 (JP) 2006-111266

(51) Int. Cl. G01B 7/30; H01F 7/06

(52) U.S. Cl. 324/207.25; 29/602.1

(57) ABSTRACT

A magnetic resolver that includes: an annular stator portion having a protruding core; an annular coil substrate on which a coil portion, which is disposed around the protruding core, is formed as a patterned thin-film coil; and a rotor portion disposed to face the stator portion from above, with the coil substrate interposed therebetween, wherein the amount of overlap between a top face of the protruding core and the rotor portion, when viewed from above, varies as a rotation angle of the rotor portion relative to the stator portion varies. The annular coil substrate may be constituted of substrate pieces that have shapes obtained by dividing the annular shape, which facilitates increasing the yield rate in the number of substrate pieces that can be produced from a substrate material.

### BACKGROUND OF THE INVENTION

1. Field of the Invention

The present invention relates to a magnetic resolver, the construction of which enhances the productivity in making the magnetic resolver, and a method of manufacturing the same.

2. Description of the Related Art

An electric motor controller that includes a Hall IC (integrated circuit) for detecting the position of a rotor may be manufactured by forming a printed board having a doughnut shape that surrounds the shaft of the rotor. Then, a first cutout is made in the printed board on the inner-diameter side of the doughnut-shaped printed board to provide the Hall IC therein, and a second cutout in the printed board on the outer-diameter side thereof to draw out the leads (see, Japanese Patent Publication No. 7-79542 (“JP 7-79542”), for example).

Generally, conventional magnetic resolvers include a rotatable rotor core; a stator core, with two stator plates that sandwich the rotor core from above and below, and that have convex, protruding poles arranged along the circumference of the stator core; and thin-film coils that are wound around the respective protruding poles of the stator core, and detect the rotation angle of the rotor core by using the fact that the inductance of a coil varies with the rotation angle of the rotor core (see, Japanese Utility Model Application Publication No. 5-3921 (“JP 5-3921”), for example).

In a conventional resolver as described in JP 5-3921, the thin-film coils are formed on a substrate in a pattern, which results in a thinner resolver body as compared to a conventional resolver in which wire is wound around the convex cores on the stator that face the rotor in the radial directions. In addition, it becomes unnecessary to wind wire to obtain coils. However, JP 5-3921 fails to disclose a specific configuration of a substrate on which the thin-film coils are formed. If a doughnut-shaped (annular) substrate is used as described in JP 7-79542 cited above, an inferior yield rate is brought about when a plurality of annular substrates are cut out of a substrate material.

### SUMMARY OF THE INVENTION

The present invention provides a magnetic resolver in a shape obtained by dividing an annular resolver, thus, allowing a plurality of substrates to be produced from a substrate material, thereby improving the yield rate, and provides a method of manufacturing the magnetic resolver.

A magnetic resolver according to a first aspect of the present invention includes: an annular stator portion having a protruding core; an annular coil substrate on which a coil portion, which is disposed around the protruding core, is formed as a patterned thin-film coil; and a rotor portion that faces the stator portion from above with the coil substrate interposed therebetween, wherein the amount of overlap between a top face of the protruding core and the rotor portion when viewed from above varies as a rotation angle of the rotor portion relative to the stator portion varies. The annular coil substrate is constituted of substrate pieces that have shapes obtained by dividing the annular shape.

A magnetic resolver according to a second aspect of the present invention is similar to that of the first aspect of the present invention, except that the substrate piece is a laminated substrate piece that is obtained by laminating a plurality of substrate pieces, on each of which at least one patterned coil is formed. With the magnetic resolver according the second aspect of the present invention, it is possible to achieve a necessary number of windings of coils without increasing the diameter of the magnetic resolver.

A magnetic resolver according to a third aspect of the present invention further includes: an annular cover that covers the coil substrate from above, sandwiching the coil substrate between the annular cover and the stator portion, and that integrates the stator portion and the coil substrate. The connection terminal for electrically connecting the patterned coils formed on their respective substrate pieces may be integrally formed with the cover. With the magnetic resolver according to the third aspect of the present invention, it is possible to easily establish an electric connection between the patterned coils of different substrate pieces.

A fourth aspect of the present invention is a method of manufacturing a magnetic resolver, including: forming, on a substrate material, a plurality of patterned thin-film coils that correspond to a plurality of coil portions, and forming a through hole in the substrate material at the center of each patterned coil; cutting the substrate material into a plurality of substrate pieces so that each substrate piece has at least one patterned coil; forming an annular coil substrate, the shape of which corresponds to the annular shape of the stator portion, by attaching, from above, at least two substrate pieces to an annular stator portion having a protruding core that is passed through the through hole; attaching a rotor portion onto the annular coil substrate from above, wherein the amount of overlap between a top face of the protruding core and the rotor portion when viewed from above varies as a rotation angle of the rotor portion relative to the stator portion varies; and electrically connecting the coil portions formed on their respective substrate pieces of the annular coil substrate.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is an exploded perspective view showing an embodiment of a magnetic resolver according to the present invention,

FIG. 2 is a diagram showing an equivalent circuit of the magnetic resolver 10 of the embodiment,

FIG. 3 is a diagram schematically showing magnetic flux in the magnetic resolver 10 of the embodiment,

FIGS. 4A and 4B are diagrams schematically showing the mechanism of variation of magnetic resistance in the magnetic resolver 10 of the embodiment,

FIG. 5A is a plan view showing a lamination of coil substrates 30 (30a, 30b and 30c) in the magnetic resolver 10 of the embodiment; and FIG. 5B is a sectional view of the coil substrates 30, which is a view on arrow Y,

FIGS. 6A and 6B are diagrams showing a significant difference in the yield rate occurring when the coil substrates 30 are produced from a rectangular substrate material 90,

FIG. 7 is a perspective view showing the assembled magnetic resolver 10,

FIG. 8 is a perspective view in which a cover 70 is viewed from below,

FIG. 9 is a diagram showing the electric connection between the substrate pieces 301 and 302 using the inter-substrate connection terminals 37,

FIG. 10 is a diagram showing another embodiment.

### DETAILED DESCRIPTION OF THE INVENTION

Embodiments of the invention will be described below with reference to the drawings.

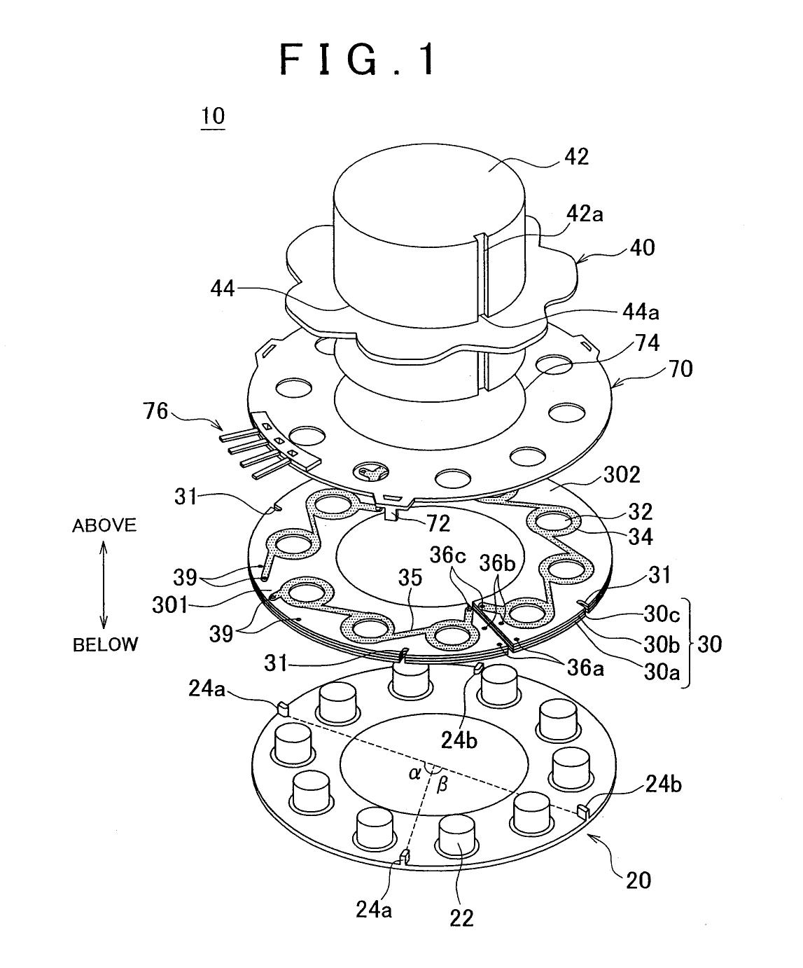

FIG. 1 is an exploded perspective view showing an embodiment of a magnetic resolver according to the present invention. In the description and the appended claims, the “above” direction does not necessarily mean the vertically upward direction in a state where the magnetic resolver is installed, but means the direction in which a rotor portion is present relative to a stator portion along the rotation axis, regardless of the orientation of the magnetic resolver once installed.

The magnetic resolver 10 of this embodiment is a variable reluctance (VR) resolver, and, as shown in FIG. 1, includes: a base plate 20 constituting the stator portion; a substrate 30 (hereinafter referred to as “the coil substrate 30”) on which coil portions are formed; and a rotor plate 40 constituting the rotor portion. As shown in FIG. 1, each of the base plate 20, the coil substrate 30, and the rotor plate 40 is formed in a disc-like shape to realize a thinner magnetic resolver 10. The base plate 20, the coil substrate 30 and the rotor plate 40 have substantially the same profile (substantially the same maximum diameter).

The rotor plate 40 is made of an iron-based magnetic material, and has an annular shape. The rotor plate 40 is typically formed of a lamination consisting of magnetic steel sheets (made of ferrosilicon, for example). The profile of the rotor plate 40 does not have a fixed diameter thus the radius periodically varies (the details of the profile will be described later). An angular multiplication factor, N, that determines the periodic variation of the radius may be appropriately determined depending on the resolution required.

The rotor plate 40 is fixed to the rotary shaft 42. The rotary shaft 42 is a shaft of which the rotation angle is to be detected by the magnetic resolver 10, and may be an output shaft of a motor, for example. A positioning protrusion 44a is formed on the periphery of a center hole 44 of the rotor plate 40, and a groove 42a corresponding to the protrusion 44a is cut in the outer circumferential surface of the rotary shaft 42 along the axial direction. The rotary shaft 42 is inserted into the rotor plate 40 in an angular relation such that the protrusion 44a fits in the groove 42a. In this way, the rotor plate 40 is held in a fixed position on the rotary shaft 42. It should be noted that the way in which the rotor plate 40 may be fixed to the rotary shaft 42 is arbitrary. A means for restricting the movement of the rotor plate 40 in the axial direction relative to the rotary shaft 42 may be additionally provided.

The base plate 20 is made of an iron-based magnetic material, and has an annular shape. The base plate 20 is typically formed of a lamination consisting of magnetic steel sheets (made of ferrosilicon, for example). The center of the annular shape of the base plate 20 coincides with the center of a rotary shaft 42 of the rotor portion.

On the base plate 20, protruding cores 22 are formed. The cores 22 are made of an iron-based magnetic material (ferrosilicon, for example) as in the case of the base plate 20. The cores 22 may be integrally formed with the base plate 20 by machining or etching, for example, or otherwise may be formed by placing, on the base plate 20, columnar laminations that are formed separately.

In this embodiment, every core 22 is a columnar protrusion having the same shape. The cores 22 are regularly arranged on the annular base plate 20 along the circumference thereof. Specifically, the centers of the cores 22 (the centers of the circles) are located on the same radius circle with the rotary shaft 42 of the rotor portion centered, at evenly spaced angular positions. In the particular embodiment shown in the drawings, for example, ten cores 22 (ten poles) are formed at 36-degree intervals.

Positioning protrusions 24 are formed on the base plate 20 along the periphery. Two pairs (24a, 24b) of positioning protrusions 24 are formed. The interval between the two positioning protrusions of one pair along the circumference is set to the same interval as that between the two positioning protrusions of the other pair along the circumference. However, this interval is set so that it differs from the interval between two positioning protrusions 24a and 24b along the circumference that belong to different pairs and are adjacent to each other. Specifically, one positioning protrusion 24a is disposed at a position that is shifted from the position of the other positioning protrusion 24a of the same pair by a first angle α, while the position of the one positioning protrusion 24a is shifted from the position of a positioning protrusion 24b of the other pair by a second angle β (≠ first angle α). Reasons for adopting this setting will be described later.

The coil substrate 30 has an annular shape, and through holes 32, through which the cores 22 are passed, are made in the coil substrate 30 along the circumference. Each through hole 32 has a circular shape corresponding to the shape of the core 22, more specifically, a circular shape with a radius equal to or slightly greater than the radius of the core 22. The through holes 32 are regularly arranged in the annular coil substrate 30 along the circumference thereof. Specifically, the centers of the through holes 32 (the centers of the circles) are located on the same radius circle with the rotary shaft 42 of the rotor portion centered, at evenly spaced angular positions. In the embodiment shown in the drawings, ten through holes 32 (ten poles) are made at 36-degree intervals, corresponding to the cores 22.

A patterned coil 34 having a spiral shape is printed around each through hole 32. The patterned coils 34 are formed by printing an electrically conductive material, such as copper, on a substrate material 90 (insulating substrate) described later. The patterned coils 34 on the same coil substrate 30 are connected in series. The connection between the patterned coils 34 may be realized by printing connection lines (electrically conductive film) 35 on the substrate material 90, except the connection portions realized by inter-substrate connection terminals 37 described later. In this case, the printing to connect the patterned coils 34 may be carried out concurrently with the printing of the patterned coils 34, so that it is possible to efficiently implement the formation of the patterned coils 34 and the electric connection therebetween on the coil substrate 30.

The protruding cores 22 pass through the through holes 32 of the coil substrate 30 when the coil substrate 30 is placed on the base plate 20. In this way, around one through hole 32, the coil portion of one pole is formed by the corresponding patterned coil 34.

It is preferable that the coil substrate 30 be provided for each of the phases (1-phase input/2-phase output, in this embodiment) individually. In the embodiment shown in the drawings, each of the coil substrate 30 that serves as excitation coils (hereinafter also referred to as “the excitation coil substrate 30a”), the coil substrate 30 that serves as coils for outputting a cosine-phase signal (hereinafter also referred to as “the cosine-phase coil substrate 30b”), and the coil substrate 30 that serves as coils for outputting a sine-phase signal (hereinafter also referred to as “the sine-phase coil substrate 30c”) are provided in separate coil substrates 30. By forming separate coil substrates 30 for each respective phase, it is possible to change the configuration of the patterned coils 34 of each phase (the adjustment or alteration to the number of windings, the winding direction or the like) without changing the coil substrate 30 of another phase, so that versatility is improved. In addition, it is possible to flexibly respond to the addition or change of the phases. For the sake of convenience in explanation, each of the plurality of insulating substrates constituting the coil substrate 30 is also referred to as the coil substrate.

It is preferable that the coil substrates 30a, 30b and 30c for each phase be formed by stacking or laminating a plurality of the coil substrates 30. In this case, the patterned coils 34 of the same pole on the coil substrates 30 of the respective layers are electrically connected in series by using via holes (not shown). In this way, it is possible to efficiently provide the required number of windings of the coil for each pole without unnecessarily increasing the radial width of the annular coil substrates 30a, 30b and 30c.

In this embodiment, the excitation coil substrate 30a is formed by stacking two layers of the coil substrates 30, and each of the cosine-phase coil substrate 30b and the sine-phase coil substrate 30c is formed by stacking six layers of the coil substrates 30. The number of windings and the winding direction of the patterned coils 34 of each pole on each of the coil substrates 30 of the respective phases are determined so that a desired sine-phase output and a desired cosine-phase output are induced as the rotor plate 40 rotates (that is, as the area of overlap between the core 22 and the rotor plate 40 varies with the rotation), as described below.

A cover 70 is placed on the top of the coil substrate 30 (the sine-phase coil substrate 30c in this embodiment) that is the uppermost one of the coil substrates stacked on the base plate 20 as described above. The cover 70 has an annular shape corresponding to the shape of the coil substrate 30. As in the case of the coil substrate 30, through holes 74 through which the cores 22 are passed are formed in the cover 70. The through holes 74 have a circular shape corresponding to the shape of the cores 22. Specifically, the radius of the circular shape is equal to or slightly greater than the radius of the core 22. The through holes 74 are regularly arranged in the annular cover 70 along the circumference. Securing tabs 72 are formed on the outer edge of the cover 70. The securing tabs 72 are formed such that the tip portions thereof engage with (hook onto) the outer edge of the base plate 20. In the embodiment shown in the drawings, three securing tabs 72 are provided along the periphery of the cover 70 at equal intervals.

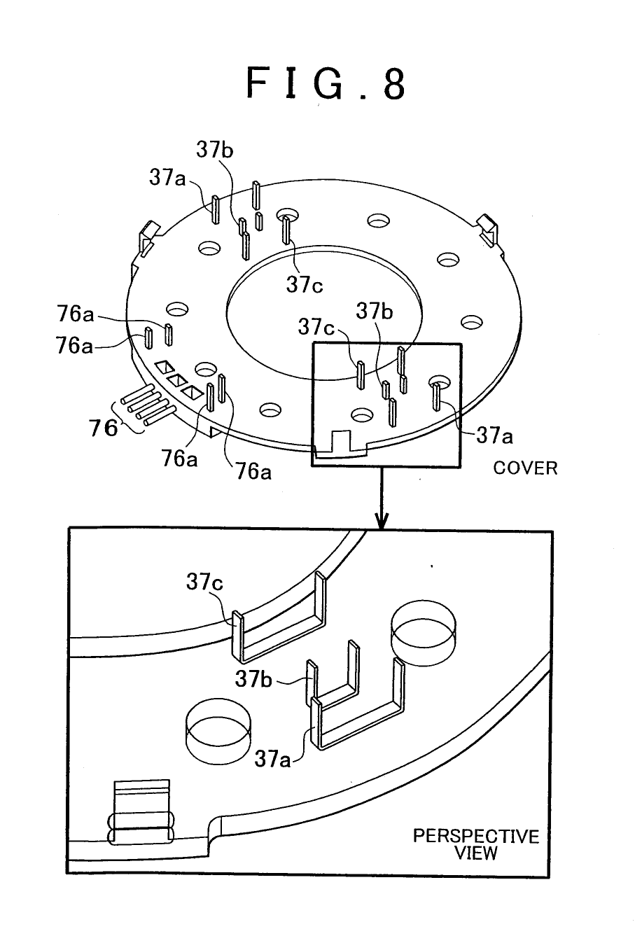

The cover 70 is provided with a connection terminal 76 and the inter-substrate connection terminals 37 (see FIG. 8). The cover 70 is manufactured by insert injection molding using polybutylene terephthalate (PBT) and brass. The connection terminal 76 has four pins (pins for an excitation phase, a sine phase and a cosine phase, as well as a pin for a ground), as shown in FIG. 1, and is connected to a connector (not shown).

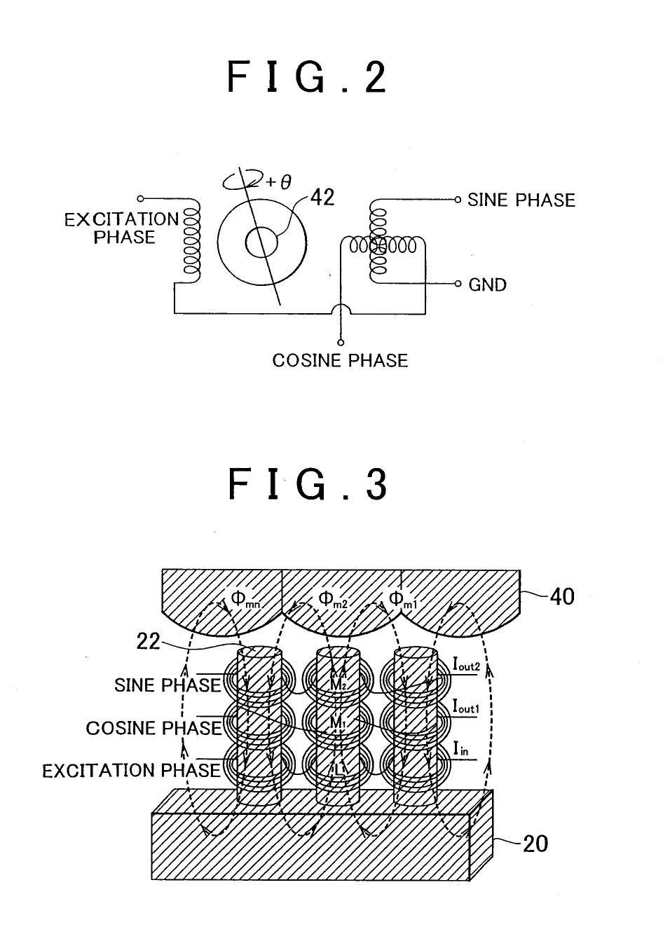

FIG. 2 shows an equivalent circuit of the magnetic resolver 10 of this embodiment formed as described above.

One end of the excitation coil (which means all of the patterned coils 34 that are connected in series on the excitation coil substrate 30a) formed on the excitation coil substrate 30a as described above is connected to a ground via the connection terminal 76, and the other end thereof is connected to an AC power source via the connection terminal 76. During operation, the AC power source applies an AC input voltage of 4 V, for example, across the excitation coil formed on the excitation coil substrate 30a.

One end of the sine-phase coil (which means all of the patterned coils 34 that are connected in series on the sine-phase coil substrate 30c) formed on the sine-phase coil substrate 30c as described above is connected to the ground via the connection terminal 76, and the other end thereof is connected to a signal processor (not shown) via the connection terminal 76. In this way, a sine-phase output voltage (induced voltage) is supplied to the signal processor mentioned above. In this embodiment, the sum of the voltages, each of which is induced across the corresponding one of the ten poles, is supplied as the sine-phase output voltage.

Similarly, one end of the cosine-phase coil (which means all of the patterned coils 34 that are connected in series on the cosine-phase coil substrate 30b) formed on the cosine-phase coil substrate 30b as described above is connected to the ground via the connection terminal 76, and the other end thereof is connected to the signal processor (not shown) via the connection terminal 76. In this way, a cosine-phase output voltage (induced voltage) is supplied to the signal processor mentioned above. In this embodiment, the sum of the voltages, each of which is induced across the corresponding one of the ten poles, is supplied as the cosine-phase output voltage.

The signal processor detects the rotation angle θ of the rotor plate 40 (the rotation angle θ of the rotary shaft 42) with the use of the following equation, based on the sine-phase output voltage and the cosine-phase output voltage:

θ=1/N·tan⁻¹ (E_{COS-GND}/E_{SIN-GND})

where E_{COS-GND} is the cosine-phase output voltage, and E_{SIN-GND} is the sine-phase output voltage.

FIG. 3 is a diagram schematically showing magnetic flux in the magnetic resolver 10 of this embodiment. FIG. 3 partially shows the magnetic flux formation in three poles. When the AC power source applies an excitation voltage to the excitation coil, a closed magnetic circuit is formed in each pair of the cores 22, which are two adjacent cores 22 having a cylindrical shape, as shown in FIG. 3. Specifically, in each pair, a closed magnetic circuit is formed that passes through one core 22, passes through the area of the rotor plate 40 from the region (overlap region) of the rotor 40 that overlaps the top face of this core 22 to the region (overlap region) of the rotor 40 that overlaps the top face of the other core 22, passes through the other core 22, passes through the area of the base plate 20 between these two cores 22, and then returns to the one core 22. Because the base plate 20 is made of a magnetic material as described above in this embodiment, it is possible to form a magnetic path of which magnetic resistance is low as compared to the case where the base plate is made of a nonmagnetic material, such as an insulating material. In this way, the ratio of the output voltage to the input voltage (transformer ratio) becomes high, and, therefore, it is possible to enhance the resolution of detecting a rotation angle.

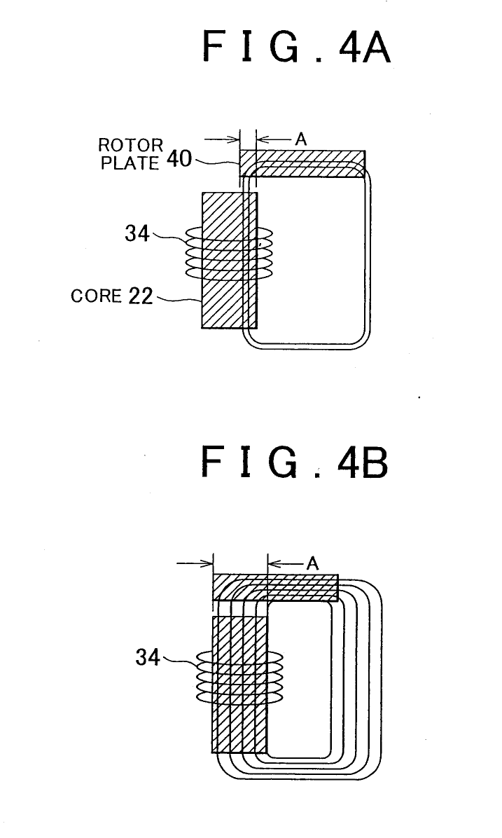

FIGS. 4A and 4B are diagrams schematically showing the mechanism of variation of magnetic resistance in the magnetic resolver 10 of this embodiment. FIGS. 4A and 4B partially show the magnetic flux formation in one pole. FIG. 4A shows a state in which magnetic flux is formed when the width A, or the area, of overlap between a peripheral portion of the rotor plate 40 and the top face of the core 22 is small. FIG. 4B shows a state in which magnetic flux is formed when the overlap width A is large. As shown in FIGS. 4A and 4B, when the width A of overlap between the peripheral portion of the rotor plate 40 and the top face of the core 22 varies, the width by which magnetic flux passing through the core 22 is blocked varies, which is accompanied by the variation of magnetic resistance. As a result, the voltage (output voltage) induced in the coil portion around the core 22 varies. The overlap width A varies as the radius of the rotor plate 40 varies with the rotation of the rotary shaft 42. The magnetic resolver 10 of this embodiment detects the rotation angle of the rotor plate 40 (the rotation angle of the rotary shaft 42), using the variation of the magnetic resistance that accompanies the rotation of the rotor.

Next, details of main components of the magnetic resolver 10 of the embodiment described above will be explained.

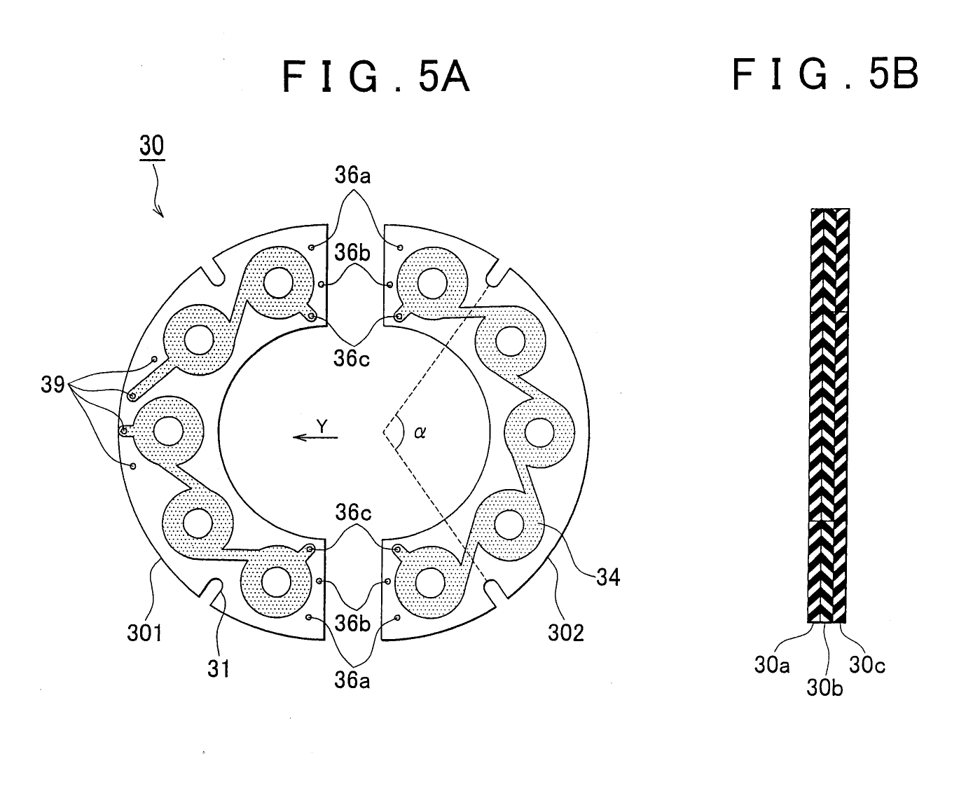

FIG. 5A is a plan view showing a lamination of the coil substrates 30 (30a, 30b and 30c) in the magnetic resolver 10 of this embodiment. FIG. 5B is a sectional view of the coil substrates 30, which is a view on arrow Y.

In this embodiment, each coil substrate 30 is constituted of substrate pieces 301 and 302 having a semiannular shape that is obtained by dividing an annular shape into two halves, as shown in FIG. 5A. Accordingly, in the case of a configuration in which a plurality of coil substrates 30 are stacked as in the case of this embodiment, the coil substrate 30 of each layer is formed of a combination of two semiannular substrate pieces 301 and 302. Hereinafter, the substrate pieces 301 and 302 mean the substrate pieces of the coil substrate 30 of an arbitrary layer. When the substrate pieces of the excitation-phase coil substrate 30a, the substrate pieces of the cosine-phase coil substrate 30b and the substrate pieces of the sine-phase coil substrate 30c are particularly distinguished from each other, these are referred to as the substrate pieces 301a and 302a of the excitation-phase coil substrate 30a, the substrate pieces 301b and 302b of the cosine-phase coil substrate 30b and the substrate pieces 301c and 302c of the sine-phase coil substrate 30c, respectively.

In each of the substrate pieces 301 and 302, two positioning notches 31 are formed symmetrically. The positioning notches 31 have a shape that fits with the positioning protrusion 24 on the periphery of the base plate 20. The two positioning notches 31 of the pair formed in the substrate piece 301 are provided at the positions one of which may be shifted from the other by the first angle α, which corresponds to the interval between the positioning protrusions 24 of the corresponding pair along the circumference. Similarly, the two positioning notches 31 of the pair formed in the substrate piece 302 are provided at the positions one of which is shifted from the other by the first angle α. Reasons for adopting this setting will be described later.

In each of the substrate pieces 301 and 302, terminal connection portions 36a to 36c, which are electrically connected to the inter-substrate connection terminals 37, will also be described later. Four terminal connection portions 39 that are electrically connected to the connection terminal 76 are formed in the substrate piece 301. The terminal connection portions 36a to 36c, and 39 may be formed as via-holes that are made in the substrate pieces 301 and 302.

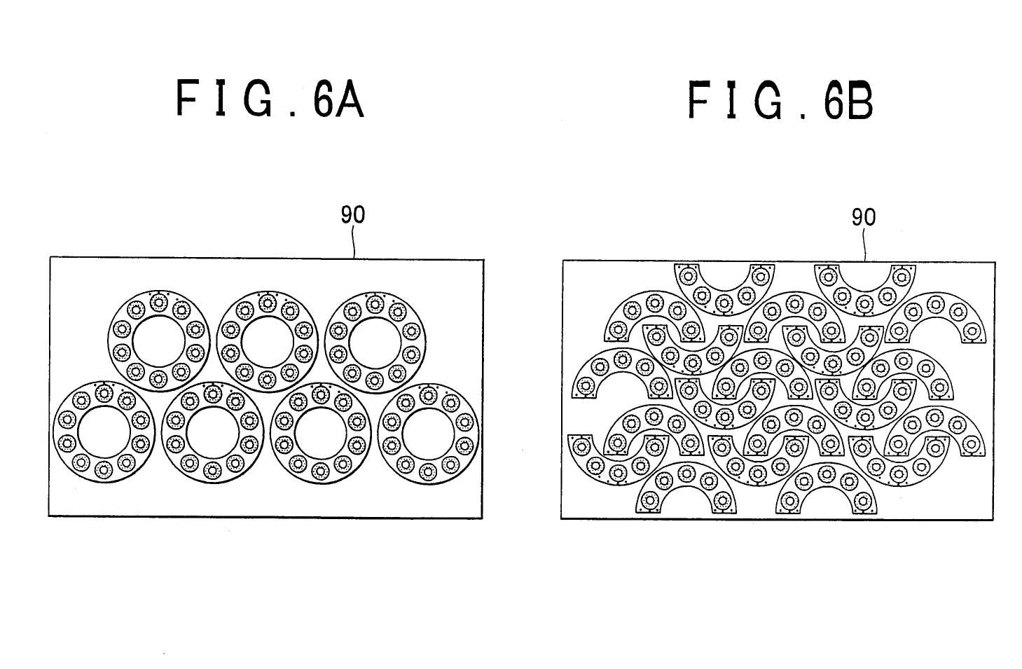

FIGS. 6A and 6B are diagrams showing a significant difference in the yield rate occurring when the coil substrates 30 are produced from a rectangular substrate material 90. FIG. 6A shows, as a comparative example, a case where annular coil substrates are cut out of a substrate material 90. FIG. 6B shows a case where semiannular substrate pieces are cut out of a substrate material 90 according to this embodiment.

When completely annular coil substrates are produced from a substrate material 90, as shown in FIG. 6A, there is relatively low flexibility in cutting pieces of material from the substrate material 90. As a result, only a relatively small number of coil substrates can be produced. As shown in FIG. 6A, no more than seven coil substrates are produced.

On the other hand, if semiannular substrate pieces are produced from the substrate material 90, as in accordance with this embodiment, as shown in FIG. 6B, the flexibility in cutting pieces of material from the substrate material 90 is significantly increased. Accordingly, when a dense arrangement for cutting pieces of material out of the substrate material 90 is adopted, it is possible to produce a relatively large number of coil substrates 30 (substrate pieces 301 and 302). As shown in FIG. 6B, it is possible to produce ten substrate pieces 301 and ten substrate pieces 302 from a substrate material 90 having the same size (accordingly, it is possible to produce ten coil substrates 30 therefrom), resulting in an improved yield rate. Thus, according to this embodiment, if the coil substrate 30 is formed of a plurality of divided substrate pieces 301 and 302, it is possible to eliminate waste by efficiently using the substrate material 90. As a result, it is possible to produce, at a low cost, the coil substrate 30, and by extension the magnetic resolver 10. The significant difference in the yield rate similarly occurs when the substrate material 90 has another shape, such as a circular shape.

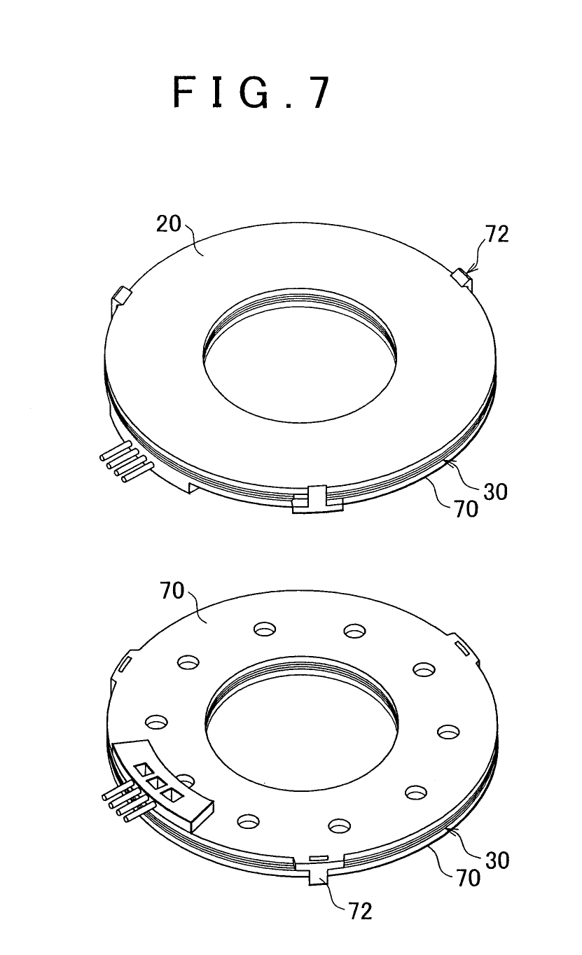

FIG. 7A is a perspective view in which the magnetic resolver 10 is viewed from below in a state where the magnetic resolver 10 has been assembled (however, the rotor plate 40 is not present). FIG. 7B is a perspective view in which the magnetic resolver 10 is viewed from above.

The excitation coil substrate 30a, the cosine-phase coil substrate 30b and the sine-phase coil substrate 30c are stacked on the base plate 20. The order in which the coil substrates 30a, 30b and 30c of the respective phases are stacked is arbitrary. The coil substrates 30 of the respective layers may be sequentially stacked on a layer-by-layer basis, wherein corresponding semiannular substrate pieces 301 and 302 are paired. By disposing a pair of semiannular substrate pieces 301 and 302 on the base plate 20, a completely annular coil substrate 30 is formed. At this time, the semiannular substrate pieces 301 and 302 are assembled such that the positioning protrusions 24 provided on the periphery of the base plate 20 fit in the positioning notches 31. As described above with reference to FIGS. 1 and 5, the interval between the two positioning notches 31 in the same semiannular substrate piece (the semiannular substrate piece 301, for example) along the circumference is equal to the interval between the two positioning protrusions of the corresponding pair in the base plate 20 (the interval between the positioning protrusions 24a and 24a, for example) along the circumference, but is not equal to the interval between the two positioning protrusions (the interval between the positioning protrusions 24a and 24b, for example) along the circumference that belong to different pairs. In this way, it is possible to prevent the semiannular substrate pieces 301 and 302 from being stacked with the semiannular substrate pieces 301 and 302 having circumferential misalignment between layers. Specifically, it is possible to align the circumferential positions of the notches in the semiannular substrate pieces 301 and 302. This is useful especially when the semiannular substrate pieces 301 and 302 are separately attached on a layer-by-layer basis.

Alternatively, the semiannular substrate pieces 301 of all the layers or of several layers may be stacked and bonded in advance, and the bonded semiannular substrate pieces 301 as a unit may be attached to the base plate 20 (see FIG. 1). Similarly, the semiannular substrate pieces 302 of all the layers or of several layers may be stacked and bonded in advance, and the bonded semiannular substrate pieces 302 as a unit may be attached to the base plate 20. In this case, the bonded semiannular substrate pieces 301 or 302 of a plurality of layers that are stacked and bonded in advance may be produced by bonding the substrate materials 90 together before cutting the semiannular substrate pieces 301 and 302 out of the substrate materials 90 (see FIG. 6B), and then cutting the semiannular substrate pieces 301 and 302 out of the bonded substrate materials 90 of a plurality of layers. Alternatively, a plurality of semiannular substrate pieces 301 or 302 may be bonded together after the semiannular substrate pieces 301 or 302 of the respective layers are cut out of the substrate material 90 (see FIG. 6B).

As shown in FIGS. 7A and 7B, the coil substrates 30a, 30b and 30c of the respective phases that are stacked on the base plate 20, as described above, are held on the base plate 20 via the securing tabs 72 of the cover 70. In this way, an assembly in which the base plate 20 and the coil substrates 30a, 30b and 30c of the respective phases are integrated is formed. In this assembly, the cores 22 of each pole and the patterned coils 34 of the corresponding pole on the coil substrates 30a, 30b and 30c of the respective phases form the coil portions of the corresponding pole of the respective phases. The tip portions (top faces) of the cores 22 of the respective poles are exposed from the cover 70 through the through holes 32 of the coil substrates 30 and the through holes 74 of the cover 70. The top faces of the cores 22 may be substantially flush with the top face of the cover 70.

FIG. 8 is a perspective view in which the cover 70 is viewed from below. FIG. 8 also shows an enlarged perspective view of a part including the inter-substrate connection terminals 37. On the underside of the cover 70, that is, on the side thereof facing the coil substrate 30, pin terminals 76a and the staple-shaped inter-substrate connection terminals 37 are disposed. These terminals are integrally formed with the body portion of the cover 70 made of a different material by insert injection molding as described above. The terminals 76a include pin terminals of four poles corresponding to the pins of the connection terminal 76, and connect to the connection terminal 76 (see FIG. 1) that protrudes from the periphery of the cover 70. Three inter-substrate connection terminals 37 are provided in two predetermined areas, each of which is shifted from the position of the area in which the terminals 76a are disposed. Hereinafter, the inter-substrate connection terminals for the excitation coil substrate 30a, the cosine-phase coil substrate 30b, and the sine-phase coil substrate 30c are referred to as the inter-substrate connection terminals 37a, the inter-substrate connection terminals 37b, and the inter-substrate connection terminals 37c, respectively.

When the cover 70 is attached to the coil substrate 30, the inter-substrate connection terminals 37a to 37c are inserted into the corresponding terminal connection portions 36a to 36c (see FIG. 5) in the substrate pieces 301 and 302.

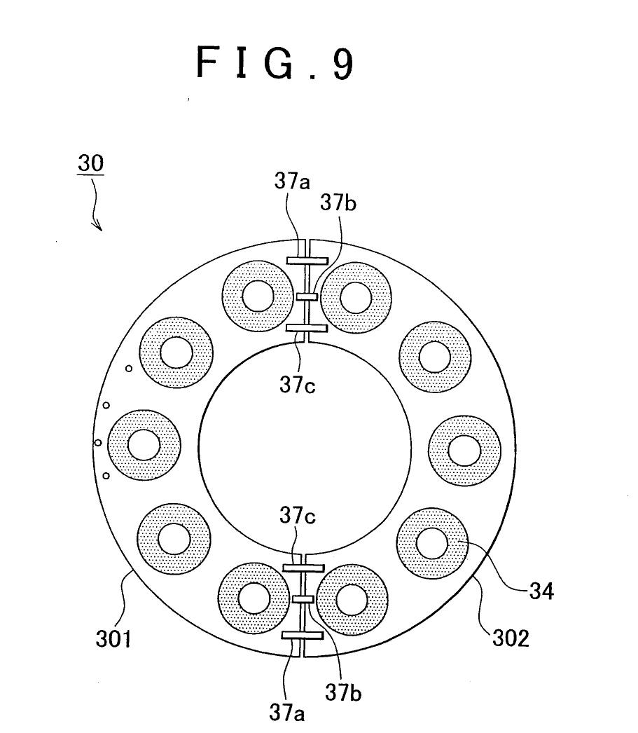

FIG. 9 is a plan view showing the electric connection between the substrate pieces 301 and 302 using the inter-substrate connection terminals 37, when the cover 70 is attached to the coil substrate 30. In FIG. 9, with regard to the cover 70, only the inter-substrate connection terminals 37a to 37c are shown.

As shown in FIG. 9, the inter-substrate connection terminals 37a are electrically connected to the corresponding terminal connection portions 36a (see FIG. 5) of the substrate pieces 301 and 302 by an appropriate method (such as soldering, welding and press-fitting). In this way, the patterned coils 34 connected in series on the respective substrate pieces 301 and 302 of the excitation coil substrate 30a are connected in series, whereby the excitation coil is formed. Similarly, the inter-substrate connection terminals 37b are electrically connected to the corresponding terminal connection portions 36b of the substrate pieces 301 and 302 by an appropriate method. In this way, the patterned coils 34 connected in series on the respective substrate pieces 301 and 302 of the cosine-phase coil substrate 30b are connected in series, whereby the cosine-phase coil is formed. Similarly, the inter-substrate connection terminals 37c are electrically connected to the corresponding terminal connection portions 36c of the substrate pieces 301 and 302 by an appropriate method. In this way, the patterned coils 34 connected in series on the respective substrate pieces 301 and 302 of the sine-phase coil substrate 30c are connected in series, whereby the sine-phase coil is formed.

Similarly, when the cover 70 is attached to the coil substrate 30, the pin terminals 76a are inserted into the terminal connection portions 39 of the substrate pieces 301 and 302. The pin terminals 76a and the terminal connection portions 39 are electrically connected by an appropriate method (such as soldering, welding and press-fitting). In this way, the electrical connection between the connection terminal 76 and the coils of the respective phases is established.

As described above, in this embodiment, even if the coil substrate 30 is constituted of a plurality of divided substrate pieces 301 and 302, when the inter-substrate connection terminals 37a to 37c are integrally formed with the cover 70, it is possible to establish the electric connection between the substrate pieces 301 and 302 relatively easily when the cover 70 is attached to the coil substrate 30. Needless to say, the inter-substrate connection terminals 37a to 37c are separately provided from the cover 70.

In the embodiment shown in FIGS. 1 to 7, an assembly including the base plate 20, the coil substrates 30 of the respective layers, and the cover 70 is formed by stacking the coil substrates 30 of the respective layers and the cover 70, respectively, over the base plate 20 (i.e., from above), so that manufacturing is very easy. In addition to the positioning function performed by the positioning protrusions 24 and the positioning notches 31 described above, the cores 22 of the respective poles on the base plate 20 perform the positioning function in cooperation with the through holes 32 of the corresponding poles. Thus, it is possible to realize highly accurate assembly by performing easy assembly work without adjustment after the assembly. Because the coil portions equivalent to the windings wound around cores are obtained by stacking the coil substrates 30 on each of which the patterned coils 34 are printed, it becomes unnecessary to wind wire around cores. In addition, by stacking the base plate 20, the coil substrates 30a, 30b and 30c of the respective phases, and the cover 70 in a plate shape, it is possible to obtain a thinner assembly. Once installed, the rotary shaft 42 (see FIG. 1) to which the rotor plate 40 has been attached is inserted into the center hole of the annular assembly shown in FIG. 7. At this time, the rotor plate 40 faces the top faces of the cores 22 in parallel therewith from above with a space therebetween.

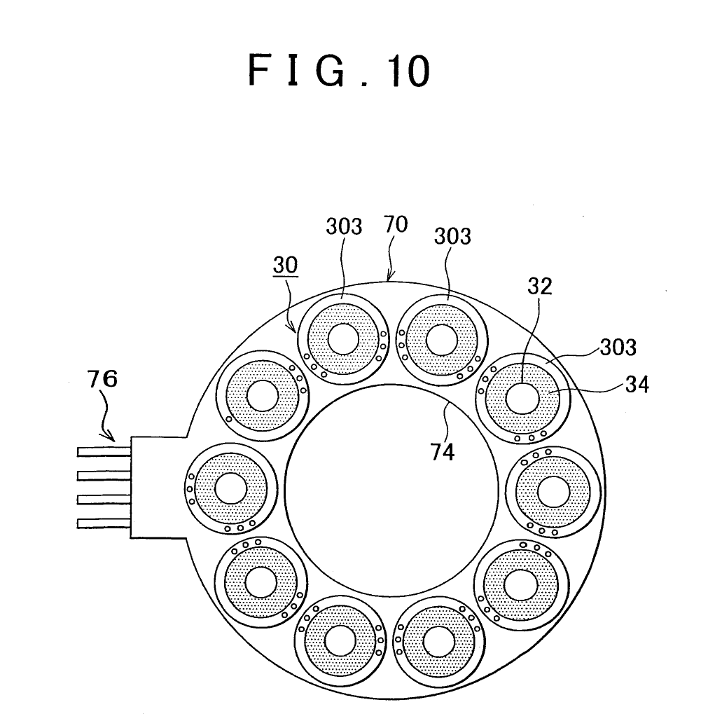

FIG. 10 is a diagram showing another embodiment, and is a plan view in which the cover 70 is viewed from below in a state where the cover 70 is attached to the coil substrate 30. In FIG. 10, the configuration of the cover 70 is schematically shown.

In the embodiment shown in FIG. 10, a substrate piece 303 that constitutes the coil substrate 30 is provided for each of the poles of the coil portions. Specifically, each coil substrate 30 includes a plurality of annular substrate pieces 303, the rough size of which is obtained by dividing the annular coil substrate 30 into ten equal parts. As in the case of the above-described embodiment, the electric connection between the substrate pieces 303 is realized by similar inter-substrate connection terminals disposed on the underside of the cover 70.

With regard to the substrate pieces 303, the flexibility in cutting pieces of material from the substrate material is high as in the case of the substrate pieces 301 and 302 in the above-described embodiment. Accordingly, when a dense arrangement for cutting pieces of material out of the substrate material is adopted, it is possible to produce a relatively large number of coil substrates 30 (substrate pieces 303).

The size of the substrate pieces 303 (the way in which the coil substrate 30 is divided) is arbitrary. In addition, it is possible to select the most suitable pattern of partition after considering the increase in the number of parts with the improvement in the yield rate with respect to material.

For example, although, in the embodiments described above, the patterned coils 34 are printed on an insulating substrate, the patterned coils 34 may be formed by any method of forming patterned coils 34 made of electrically conductive film (thin film). The patterned coils 34 may be formed by using another printing technology, such as a film transfer method, by disposing and bonding a film, in which a similar coil pattern is formed, on the substrate, or by stamping, vapor deposition, etc.

In addition, although, in the embodiments described above, the annular coil substrate 30 is constituted of the substrate pieces (301 and 302, or 303) that have the same shape, the annular coil substrate 30 may be formed of substrate pieces that have different shapes. For example, the annular coil substrate 30 may be formed by combining a semiannular substrate piece that has a central angle of about 120°, and a semiannular substrate piece that has a central angle of about 240°.

Although, in the above embodiments, the “1-phase input/2-phase output” configuration is adopted, “1-phase input/1-phase output” configuration may be adopted. The particular configuration of the phase is arbitrary.

Although example embodiments of the present invention have been described in detail, the present invention is not limited to the above-described embodiment. Various modifications and substitutions can be made to the above-described embodiment without departing from the scope of the present invention. The present invention may be used in all kinds of apparatuses that detect the rotation angle of a rotor, such as, for example, rotation angle sensors that detect a rotation angle of a shaft in a power steering system.

1. A magnetic resolver comprising:
an annular stator portion having a protruding core;
an annular coil substrate on which a coil portion, which is disposed around the protruding core, is formed as a patterned thin-film coil; and
a rotor portion that faces the stator portion from above with the coil substrate interposed therebetween, wherein the amount of overlap between a top face of the protruding core and the rotor portion, when viewed from above, varies as a rotation angle of the rotor portion relative to the stator portion varies,
wherein the annular coil substrate is constituted of substrate pieces that have shapes obtained by dividing the annular shape.

2. The magnetic resolver according to claim 1, wherein
the substrate piece is a laminated substrate piece that is obtained by laminating a plurality of substrate pieces, on each of which at least one patterned coil is formed.

3. The magnetic resolver according to claim 1, further comprising:
an annular cover that covers the coil substrate from above, sandwiching the coil substrate between the annular cover and the stator portion, and that integrates the stator portion and the coil substrate,
wherein a connection terminal that electrically connects the patterned coils formed on the respective substrate pieces is integrally formed with the cover.

4. A method of manufacturing a magnetic resolver comprising:
forming, a plurality of patterned thin-film coils on a substrate material, and a through hole in the substrate material at the center of each patterned coil;
cutting the substrate material into a plurality of substrate pieces so that each substrate piece has at least one patterned thin-film coil;
forming an annular coil substrate, the shape of which corresponds to the annular shape of the stator portion, by attaching, from above, at least two substrate pieces to an annular stator portion having a protruding core that is passed through the through hole;
attaching a rotor portion onto the annular coil substrate from above, wherein the amount of overlap between a top face of the protruding core and the rotor portion, when viewed from above, varies as a rotation angle of the rotor portion relative to the stator portion varies; and
electrically connecting the patterned thin-film coils formed on the respective substrate pieces of the annular coil substrate.
